(19) United States
(12) Patent Application Publication
(10) Pub. No.: US 2003/0160725 A1
(43) Pub. Date: Aug. 28, 2003

(54) Lapel-Mounted global positioning system antenna in a portable communication device

(76) Inventors: Paul Baxter, Bedfordshire (GB); Cesar D. Maiorino, Princeton, MA (US); Bruce E. Murphy, Hudson, NH (US)

Correspondence Address: TYCO Technology Resources, Suite 450, 4550 New Linden Hill Road, Wilmington, DE, 19808-2952, US

(21) Appl. No.: 10/083,937

(22) Filed: Feb. 27, 2002

(51) Int. Cl. H01Q 1/24

(52) U.S. Cl. 343/702; 343/718

(57) ABSTRACT

A lapel-mounted Global Positioning System antenna integrates Global Positioning System technology with portable communication devices for the purpose of identifying and transmitting the location, velocity, and time of the portable device.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

In certain portable communication devices, such as portable radios and cellular telephones, it would be desirable for the device to be able to transmit identification and location information. For example, it would be useful for communication devices carried by emergency personnel to convey their location information to dispatchers in situations in which voice contact may be lost or impossible. As another example, it would be helpful for cellular telephones to transmit the callers' locations to emergency 911 services.

The Global Positioning System (GPS) is an accurate and useful radio navigation system for obtaining location information. In GPS, a constellation of twenty-four satellites in orbit about 11,000 nautical miles above the earth continuously broadcast time, instantaneous position, almanacs and ephemeris (parameters that describe the satellite's orbit) data using code-division multiple access spread-spectrum communication methods. Each satellite broadcasts on the same frequency, but uses a different pseudo-random noise code.

A GPS receiver located in a device on the earth's surface receives the signals from the satellites to accurately determine the device's three-dimensional position, velocity, and time. A receiver acquires a satellite's signal by correlating the satellite's signal with a copy of the periodic pseudo-random noise code stored in the receiver. Using trilatteration techniques, the receiver is able to calculate its position, time and velocity. The receiver must lock onto the signals from a minimum of four satellites to eliminate clock synchronization error in the receiver.

### SUMMARY OF THE INVENTION

The time it takes a Global Positioning System (GPS) receiver to calculate the position, time, and velocity data and the accuracy of its calculations depend on the number of satellites that can be observed by the Global Positioning System (GPS) antenna. For some portable applications that use the GPS system, the location information must be available on demand. The present invention integrates a GPS antenna into a portable communication device in a manner that increases the likelihood that a maximum number of satellites are in view of the receiver at any given moment.

The GPS antenna is integrated into a portable communication device, such as a lapel-mounted microphone, with an optimized orientation. In this manner, the device of the present invention ensures optimum system performance.

### DESCRIPTION OF THE DRAWINGS

The invention will be more fully understood from the following detailed description taken in conjunction with the accompanying drawings in which:

FIG. 1 is a schematic view of a portable communication device housing a Global Positioning System antenna and associated circuitry worn by a user according to the present invention;

FIG. 2 is an isometric view of an embodiment of the portable communication device of FIG. 1;

FIG. 3 is an isometric view of the lapel housing of the portable communication device of FIG. 2;

FIG. 4 is a side view of the lapel housing of the portable communication device of FIG. 2;

FIG. 5 is a lower exploded view of the lapel housing of FIG. 2; and

FIG. 6 is an upper exploded view of the lapel housing of FIG. 2.

### DETAILED DESCRIPTION OF THE INVENTION

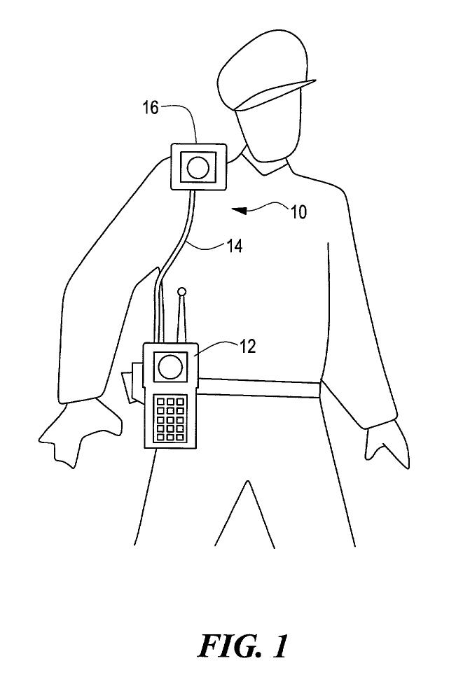

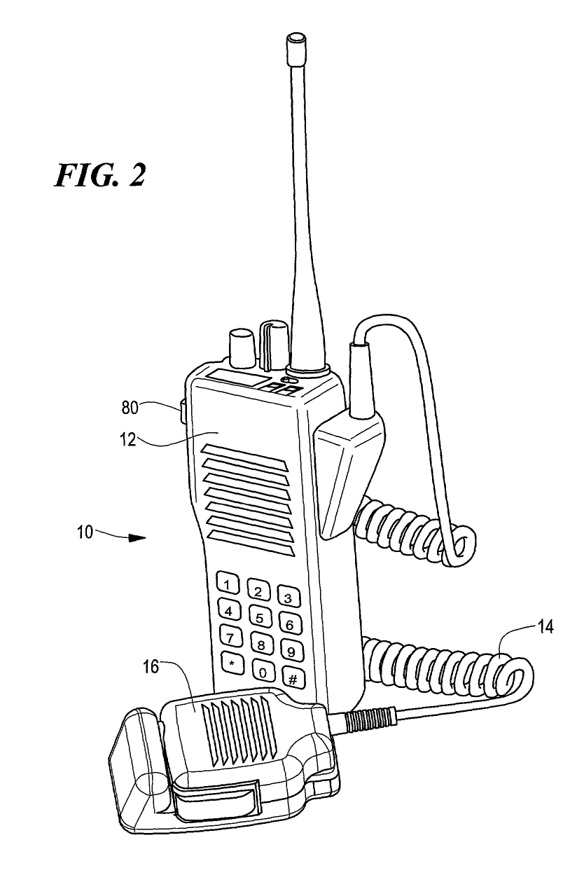

A portable communication device 10 within which a Global Positioning System (GPS) antenna and associated circuitry are housed according to the present invention is illustrated generally in FIGS. 1 and 2. The device illustrated is a portable two-way radio, although other types of portable communication devices may employ the present invention. The radio is contained in a housing 12 worn at the waist of a user using a suitable waist mounting, such as a clip or loop. The radio is connected via a cable 14 to a microphone and speaker disposed in a housing 16 that is attached to the lapel of the user's clothing via a suitable lapel mounting, such as a clip. The radio is used for communication by the user with personnel at a service center. The radio is capable of transmitting and receiving both voice and data in a given bandwidth, preferably simultaneously, although this is not necessary for operation of the present invention. Appropriate software and hardware for communication with the radio are located at the service center.

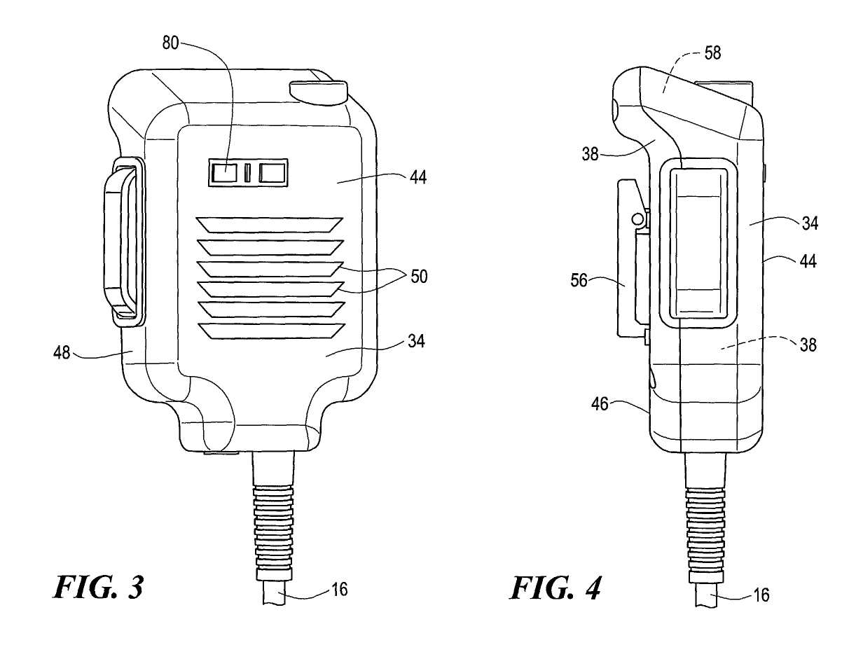

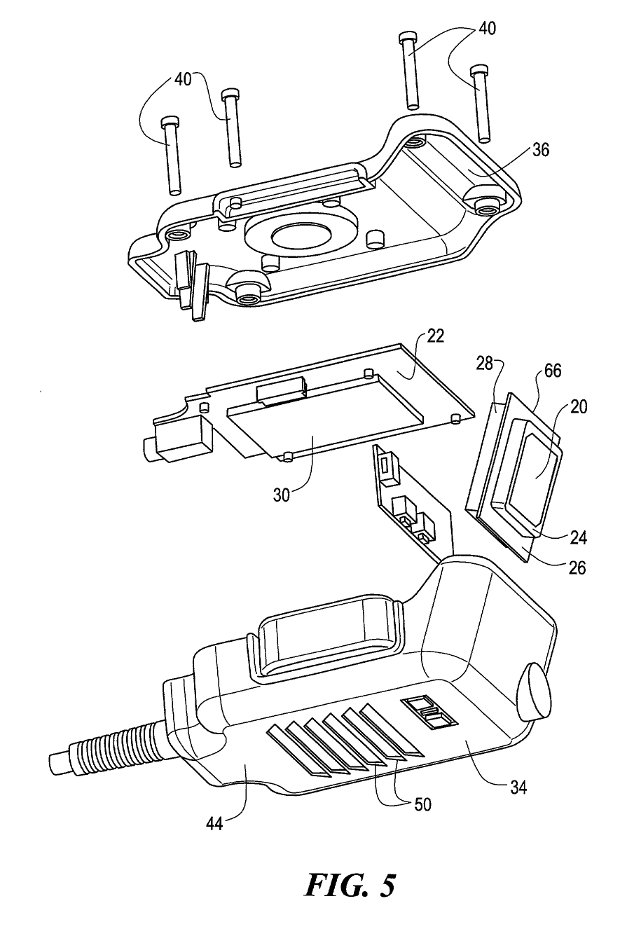

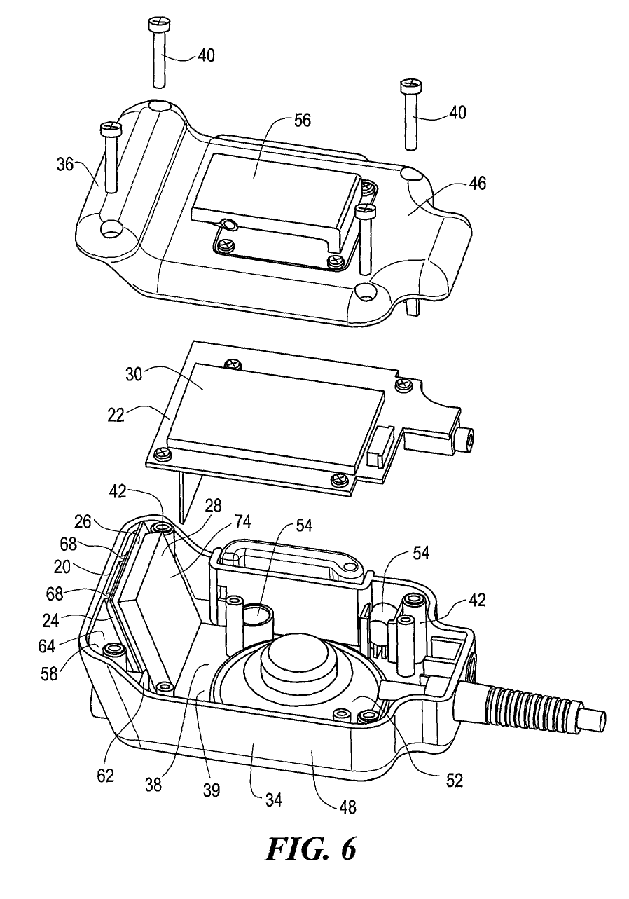

The lapel housing 16 is illustrated more particularly in FIGS. 3-6. A typical GPS antenna 20, also known as a patch antenna, and a GPS receiver on a printed circuit board 22 are mounted within the lapel housing 16. The GPS antenna includes a metallic pattern (not illustrated for clarity) optimized for the reception of GPS signals and printed on one side of a slab of dielectric material 24 mounted on a substrate 26. This beam pattern requires that the antenna be mounted in a horizontal plane to optimize the detection of signals from the GPS satellites. Suitable active circuitry 28 for boosting the signal is provided on the other side of the substrate. The receiver board 22 is in electrical communication with the antenna in any suitable manner, such as via contacts along the edges of the board 22 and the antenna 20 (not illustrated for clarity). Shielding 30 against electromagnetic interference is provided on both sides of the receiver board 22. The receiver decodes the position information passed to it from the antenna, as known in the art. Power is brought to the GPS antenna and receiver via the cable 16.

In the embodiment illustrated, the lapel housing 16 is formed in two pieces, a front piece 34 and a back piece 36, fastened together in any suitable manner, such as by screws 40 that connect to integrally molded screw locks 42. The housing includes an interior cavity 38 in which the various components are contained. When the front piece 34 and back piece 36 are assembled, the housing has generally parallel front and rear faces 44, 46 and opposed side faces 48. A speaker 52 and one or more microphones 54 are disposed in a main portion 39 of the interior cavity 38 of the housing, directed toward the front face of the housing. The front face includes suitable openings 50 for functioning of the speaker 52 and the microphone(s) 54. The back face includes a suitable lapel mounting, such as a clip 56, for attachment to the wearer's lapel.

An upper portion 58 of the interior cavity 38 of the housing 16 is sized and configured to define an antenna recess to receive the GPS antenna 20 at approximately a 70° angle with respect to the front face 44 of the housing 16. This angle provides an optimal position to retain the antenna in a horizontal orientation when the lapel housing is attached to the user's clothing. It will be appreciated that this angle is selected to achieve a horizontal orientation suitable for the particular device of interest.

A suitable retaining mechanism is provided in the antenna recess to hold the antenna in place. For example, a pair of flanges 62 (one shown) may be provided configured such that a substrate 26 of the antenna 20 fits between the flanges and an inner wall 64 at the upper portion 58 of the housing. The back piece 36 of the housing may abut against a back edge 66 of the substrate 26 of the GPS antenna to prevent the antenna from jostling within the housing. The top of the antenna is also spaced a suitable distance from the inner wall 64 of the antenna recess, as required for proper functioning of the antenna. A pair of ribs 68 may be provided to space the antenna. A suitable spacing is 0.045 inch. A greater spacing may be used while still achieving functionality of the antenna, although a greater spacing increases the overall size of the housing. The flanges and ribs may be integrally molded with the housing or formed in any other suitable manner, as would be known in the art. Similarly, any other manner of retaining the GPS antenna in the housing may be provided to avoid jostling movement and provide a suitable spacing from the inner wall, as would be appreciated by one of ordinary skill in the art.

The GPS receiver circuitry contained on the printed circuit board 22 is also mounted in the main portion 39 of the interior cavity 38 generally parallel to the front and rear faces 44,46 of the housing. In this manner, the receiver circuitry increases the size of the housing a minimum extent. A switch board 72, containing circuitry for operation of externally located, user accessible buttons, is connected to the main circuit board near an upper edge of the circuit board 22 generally in a region 74 between the main portion 39 of the cavity and the upper portion 58 defining the GPS antenna recess. The GPS antenna 20 is located above the switch board 72. The GPS antenna is connected to the GPS circuit board 22 in any suitable manner, such as with a co-axial cable (not shown for clarity), as would be known in the art.

Other components, as would be known in the art, are included as necessary for operation of the device. For example, a voltage rail and voltage regulator with sufficient current capacity to drive all the electronics are provided to the lapel housing via the connecting cable from the radio.

Communication between the radio and the GPS receiver may occur in any suitable manner. For example, communication may be routed through the cable and the microphone to the receiver. Thus, location information is conveyed from the receiver down the cable to the radio in the waist mounting. The GPS receiver is configured to provide serial messages in any suitable data format, such as NMEA-109 ASCII, for communication to the radio.

Transmission of position information from the radio may occur in any desired mode. For example, the information may be continuously transmitted at a requested update rate on receipt of a single polled message from the service center. Alternatively, the information may be transmitted as a single response to a request when the radio is directly polled by the service center. Additionally, the information may be transmitted in response to an action by the user, such as by activation of an emergency switch 80 the side of the radio. The radio software is suitably configured to ensure that the GPS receiver is compatible with the appropriate protocol(s) used for emergency transmissions. The service center is able to detect the transmission and map match the position with reference to an appropriate map, such as a street map of the appropriate locality. The service center is also able to produce a suitable visible and/or audible alarm with an indication of the transmission's emergency significance.

In another embodiment, the receiver is contained within the waist mounting with the radio. GPS signals received by the antenna are conveyed down the cable to the GPS receiver in the radio, where the receiver extracts the location information for transmission by the radio.

By removing the GPS antenna from the portable device itself, the antenna is removed from the user's waist area or hand, where the GPS satellites could be obscured by the user's torso and/or head. In this manner, the antenna is more likely to be in view of a maximum number of satellites at any given moment, and the antenna is optimally oriented for GPS performance. Degradation of GPS performance is thereby minimized or eliminated with the present invention.

The invention is not to be limited by what has been particularly shown and described, except as indicated by the appended claims.

1. A portable communication device comprising:
a two-way radio assembly comprising a radio transceiver, a microphone, and a speaker;
at least a portion of the radio assembly disposed within a housing attachable to clothing of a user with an attachment device;
a global positioning system antenna and global positioning system receiver disposed within the housing in communication with the radio transceiver; and
the global positioning system antenna oriented to lie in a generally horizontal plane when the housing is attached to the clothing on the upper body of the user.

2. The portable communication device of claim 1, wherein the generally horizontal plane is sufficiently horizontal to maximize a number of global positioning system satellites that are simultaneously viewable by the antenna.

3. The portable communication device of claim 1, wherein the housing includes an interior cavity, an upper portion of the interior cavity comprising a recess sized and configured to house the global positioning system antenna.

4. The portable communication device of claim 3, wherein the recess is oriented to maintain the global positioning system antenna in the generally horizontal plane.

5. The portable communication device of claim 3, wherein the recess is oriented to maintain the global positioning system antenna at an approximately 70° angle with respect to a front face of the housing.

6. The portable communication device of claim 3, wherein a spacing element is provided in the recess to space the global positioning system antenna from an interior surface of the housing a distance sufficient to maintain antenna functionality.

7. The portable communication device of claim 6, wherein the spacing element comprises a pair of ribs extending from the interior surface of the housing.

8. The portable communication device of claim 3, wherein a retaining element is provided in the recess to retain the global positioning system antenna within the recess.

9. The portable communication device of claim 8, wherein the retaining element comprises a pair of flanges cooperative with a pair of ribs formed in the recess.

10. The portable communication device of claim 1, wherein the attachment device comprises a clip.

11. The portable communication device of claim 1, wherein the microphone and the speaker are disposed in the housing, and the radio transceiver is disposed in a second housing.

12. The portable communication device of claim 11, wherein a cable is provided between the housing and the second housing, the cable operative to transmit power to the antenna and the receiver in the housing.

13. The portable communication device of claim 11, wherein a cable is provided between the housing and the second housing, the cable operative to transmit signals between the housing and the second housing.

14. The portable communication device of claim 1, wherein the receiver is disposed on a printed circuit board, the antenna connected to the printed circuit board.

15. The portable communication device of claim 14, wherein the printed circuit board is disposed in the housing generally in alignment with front and back faces of the housing.

16. The portable communication device of claim 1, wherein the housing is formed of two parts fastened together.

17. The portable communication device of claim 1, wherein the global positioning system antenna and receiver are operative to determine location, velocity and time of the portable communication device using data from global positioning system satellites in orbit above earth.

18. The portable communication device of claim 1, wherein the global positioning system antenna and receiver are operative to transmit data representative of location, velocity and time of the portable communication device upon receipt of a requesting signal from an external source.

19. The portable communication device of claim 1, wherein the global positioning system antenna and receiver are operative to periodically transmit data representative of location, velocity and time of the portable communication device upon receipt of a requesting signal from an external source.

20. The portable communication device of claim 1, further comprising an external actuator in communication with the global positioning system receiver operable to cause the global positioning system receiver to transmit data representative of location, velocity and time of the portable communication device.

21. A portable communication device comprising:
a two-way radio assembly comprising a radio transceiver, a microphone, and a speaker;
at least a portion of the radio assembly disposed within a housing attachable to clothing of a user with an attachment device;
a global positioning system antenna and global positioning system receiver disposed within the housing in communication with the radio transceiver;
the global positioning system antenna oriented to lie in a plane that is sufficiently horizontal to maximize a number of global positioning system satellites that are simultaneously viewable by the antenna when the housing is attached to the clothing on the upper body of the user, wherein the global positioning system antenna and receiver are operative to determine location, velocity and time of the portable communication device using data from global positioning system satellites in orbit above earth.
